(19) United States
(12) Patent Application Publication
(10) Pub. No.: US 2026/0036077 A1
(43) Pub. Date: Feb. 5, 2026

(54) TURBINE

(71) Applicant: Cummins Ltd, London (GB)

(72) Inventors: Thomas Morton, London (GB); James McEwen, London (GB); John Bywater, London (GB)

(21) Appl. No.: 18/997,464

(22) PCT Filed: Jul. 20, 2023
(86) PCT No.: PCT/GB2023/051918

§ 371 Date: Jan. 21, 2025

(30) Foreign Application Priority Data
Jul. 22, 2022 (GB) 2210726.2

(51) Int. Cl. F02B 37/18; F16K 1/20

(52) U.S. Cl. CPC F02B 37/183; F16K 1/2042

(57) ABSTRACT

A turbine comprising a wastegate chamber (28): a turbine housing (12) defining a turbine inlet (14), the turbine housing (12) comprising: a wastegate inlet passageway (30) defining a flow path between the turbine inlet (14) and the wastegate chamber (28), wherein the wastegate inlet passageway (30) comprises a turbine port (38) proximal the turbine inlet (14) and a non-circular valve port (36) proximal the wastegate chamber (28), and a raised rim (52) surrounding the non-circular valve port (36) and conformal to the shape of the non-circular valve port (36), wherein the raised rim comprises a first sealing surface (52); and a valve member (42) comprising a second sealing surface (50), wherein the valve member (42) is moveable between a closed position in which the second sealing surface (50) forms a seal with the first sealing surface (54) to prevent fluid flow along the flow path and an open position in which the second scaling surface (50) is spaced apart from the first sealing surface (54) to permit fluid flow along the flow path.

### CROSS-REFERENCE TO RELATED PATENT APPLICATIONS

The present application is a U.S. national stage of and claims the benefit of priority to International Patent Application No. PCT/GB2023/051918, filed Jul. 20, 2023, which claims priority to GB 2210726.2, filed Jul. 22, 2022, the entire contents of which are incorporated herein by reference in their entirety.

### FIELD

The present disclosure relates to a turbine, for example in a turbocharger or other turbomachine. In particular, the present disclosure relates to a turbine with a wastegate having a wastegate inlet passageway with a non-circular valve port.

### BACKGROUND

Turbines convert the potential energy of a fluid into mechanical work. Conventional turbines comprise a turbine housing defining a turbine inlet, a turbine chamber and a turbine outlet. A turbine wheel is mounted within the turbine chamber. The turbine inlet commonly comprises an annular inlet defined between facing radial walls arranged around the turbine chamber and an inlet volute arranged around the annular inlet. In use, fluid enters the turbine through the turbine inlet, where it is passed to the turbine wheel in the turbine chamber. The fluid impinges upon one or more blades defined by the turbine wheel, thus exerting a force upon the turbine wheel causing the turbine wheel to spin. Once the fluid has passed the turbine wheel, it exits the turbine via the turbine outlet.

Turbochargers are well known turbomachines for supplying air to an inlet of an internal combustion engine at pressures above atmospheric pressure (boost pressures). Turbochargers increase the pressure of atmospheric air entering into an internal combustion engine using a turbine and a compressor mounted to a common shaft. Exhaust gasses from an outlet manifold of the internal combustion engine are passed through the turbine. Rotation of the turbine wheel causes rotation of the shaft and thus the compressor wheel. Air is drawn through the compressor and compressed by the compressor wheel to a boost pressure. By providing higher pressure air to the internal combustion engine, more oxygen is available within the internal combustion engine for the combustion of fuel. As such, the turbocharger permits more fuel to be combusted, and hence the internal combustion engine may produce more power.

It is known to provide a turbine with a bypass, typically referred to as a wastegate, that permits fluid to flow from the turbine inlet to the turbine outlet without passing through the turbine wheel. Wastegates are typically fitted with a wastegate valve (e.g. a poppet type valve or a swing type valve) configured to permit or prevent flow from bypassing the turbine wheel.

The wastegate comprises a wastegate chamber within which the wastegate valve is located. The wastegate chamber is commonly at least partially defined by the turbine housing. The wastegate further includes a wastegate inlet passageway extending through the turbine housing between the turbine inlet and the wastegate chamber. The end of the wastegate inlet passageway proximal the turbine inlet is herein referred to as a turbine port, and the end of the wastegate inlet passageway proximal the wastegate chamber is herein referred to as a valve port. The wastegate inlet passageway provides a fluid flow path between the turbine inlet and the wastegate chamber. The wastegate further comprises a wastegate outlet providing a fluid flow path between the wastegate chamber and the turbine outlet or the atmosphere.

The wastegate valve includes a valve member that is movable within the wastegate chamber. For example, where the wastegate valve is a swing type valve, the valve member may be mounted on an arm which is rotatable about a pivot mounted to the wastegate chamber and spaced from the wastegate valve. The wastegate is closed by moving the valve member to an advanced position at which it blocks the valve port of the wastegate inlet passageway, thereby preventing gas from entering the wastegate chamber and ensuring that the gas impinges on the turbine wheel. The wastegate is opened by moving the valve member away from the valve port of the wastegate inlet passageway to a retracted position. This allows gas from the turbine to enter the wastegate chamber through the wastegate inlet passageway between the valve member and the wall of the wastegate chamber, thereby bypassing the turbine wheel.

When used in a turbocharger, the wastegate is opened to permit fluid to bypass the turbine wheel when the boost pressure of the fluid in the compressor outlet increases above a pre-determined level. An actuator closes the wastegate by moving the wastegate valve to the advanced position and retaining it there. The required actuator force to maintain the valve member in the advanced position, and thus keep the wastegate closed, is dependent on the force of fluid in the turbine acting on the valve member at the valve port, which is balanced by the actuator force. The fluid force is proportional to the area of the valve member upon which the fluid acts. The area of the valve member upon which the fluid acts depends on the location of the seal formed by the valve member around the valve port. This area may be difficult to predict if the location of the seal between the valve member and the wall of the wastegate chamber is poorly defined, for example due to large component manufacturing tolerances.

EP2489853A1 relates to a wastegate comprising a wastegate inlet passageway which has a circular cross section and an axis which extends perpendicular to the surface of the wall of the wastegate chamber against which the valve member seals, thus the wastegate has a circular valve port. The valve member takes the form of a disc. It is disclosed that either the valve member or the wall of the wastegate chamber circumscribing the circular valve port may comprise a raised annular rim that defines a sealing surface. This sealing surface is intended to reduce the incidence of fluid leakage out of the bypass passage between the valve member and the wall of the wastegate chamber. Leakage of fluid from the bypass passage into the wastegate chamber when the wastegate is closed may have an adverse effect on the performance and/or efficiency of the turbine and/or turbocharger.

It is an object of the present disclosure to provide an improved wastegate having a non-circular valve port, which may for example provide greater flexibility in packaging, a simpler apparatus, improved efficiency, greater accuracy in tuning or operation, etc.

### SUMMARY

According to a first aspect there is provided a turbine comprising a wastegate chamber. The turbine further comprises a turbine housing. The turbine housing defines a turbine inlet. The turbine housing comprises a wastegate inlet passageway. The wastegate inlet passageway defines a flow path between the turbine inlet and the wastegate chamber. The wastegate inlet passageway comprises a turbine port proximal the turbine inlet and a non-circular valve port proximal the wastegate chamber. The turbine housing further comprises a raised rim surrounding the non-circular valve port and conformal to the shape of the non-circular valve port. The raised rim comprises a first sealing surface. The turbine further comprises a valve member. The valve member comprises a second sealing surface. The valve member is moveable between a closed position in which the second sealing surface forms a seal with the first sealing surface to prevent fluid flow along the flow path and an open position in which the second sealing surface is spaced apart from the first sealing surface to permit fluid flow along the flow path.

The non-circular valve port may allow greater flexibility in the packaging of the wastegate and of the turbine, widening the options for machining.

Beneficially, the first sealing surface of the raised rim may provide a controlled sealing location between the valve member and the turbine housing. This may allow for accurate prediction of the area of the valve member upon which fluid pressure from the valve port acts when the valve member is in the closed position, therefore an actuator controlling the wastegate may be tuned with greater accuracy to move the valve member between the closed and open positions at the appropriate times. Furthermore, having a controlled contact area between the valve member and the housing via the raised rim may provide improved sealing. Improved sealing leads to improved efficiency of the turbine when the valve member is in the closed position.

The non-circular valve port may have a major dimension defined by a maximum distance between opposing points on the valve port. The second sealing surface may have a minor dimension defined by a minimum distance between opposing points on an outer edge of the second sealing surface. The minor dimension of the second sealing surface may be greater than the major dimension of the non-circular valve port.

The minor dimension of the second sealing surface being greater than the major dimension of the non-circular valve port, so that the second sealing surface on the valve member forms a seal with first sealing surface on the raised rim, may allow the valve member to be manufactured with large tolerances without impacting the function of the wastegate or the efficiency of the turbine. Provided that the minor dimension of the second sealing surface is greater than the major dimension of the non-circular valve port, the second sealing surface may form a seal with first sealing surface regardless of how much larger the minor dimension of the second sealing surface is compared to the minor dimension of the non-circular valve port. Furthermore, the relative dimensions of the valve port and the valve member may allow for a simple wastegate arrangement without the need for an anti-rotation feature to prevent the valve member rotating relative to the raised rim. A seal may be formed when the first and second sealing surfaces are in contact, regardless of the orientation of the valve member relative to the raised rim. The second sealing surface may define a valve axis through its centre and the valve member may be free to rotate around the valve axis. The valve member being free to rotate may reduce uneven wear on the sealing surface of the valve member.

The non-circular valve port may define a plane. The wastegate inlet passageway may extend along a passage axis that is at an oblique angle to the plane of the non-circular valve port.

Beneficially, a favourable angle of the flow path through the wastegate inlet passageway from the turbine inlet can be achieved, thereby improving the wastegate discharge coefficient and the operation of the turbine and/or turbocharger. Furthermore, the oblique angle of the wastegate inlet passageway relative to the valve port allows greater flexibility in the packaging of the wastegate and turbine, widening the options for machining.

The major dimension of the non-circular valve port may be at least 15 mm. The major dimension of the non-circular valve port may be up to 40 mm.

The wastegate inlet passageway may have a non-circular axial cross-section i.e. elliptical, teardrop shaped, pear shaped, square, or irregularly shaped. Alternatively, the wastegate inlet passageway may have a circular axial cross-section.

The shape of the non-circular valve port may be the same shape as the axial cross-section of the wastegate inlet passageway where the passage axis is perpendicular to the plane of the valve port. Alternatively, the shape of the non-circular valve port may be different to the shape of the axial cross-section of the wastegate inlet passageway where the passage axis is at an oblique angle to the plane of the valve port.

The non-circular valve port may be elliptical, teardrop shaped, pear shaped, square, or irregularly shaped. The valve port may be shaped to optimize the gas flow through the valve port when the valve member is in the open position. The valve port may be shaped to permit alternative packaging arrangements of the wastegate.

Where the valve port has an elliptical shape, the elliptical valve port may be defined by a major diameter and a minor diameter. The major dimension of the elliptical valve port may be the major diameter. The first sealing surface may have the form of an elliptical ring.

The first sealing surface may have a constant width. The major dimension of the first sealing surface may be equivalent to the major dimension of the valve port plus two times the width of the first sealing surface. The width of the sealing surface may be between 1 mm and 5 mm. Beneficially, the sealing surface is an optimal width that is large enough to be sufficiently durable to the environment within the turbine and hot gases that may pass through the wastegate, and small enough to provide an accurate sealing location so that the gas force acting on the valve member in the closed position can be accurately estimated and the wastegate actuator can be accurately tuned. Furthermore, minimizing the width of the land reduces the amount of free space around the valve port that is required to give line of sight and access during machining.

The second sealing surface may be circular. The minor dimension of the second sealing surface may be the diameter of the second sealing surface.

Beneficially, a standard valve may be used. Furthermore, the valve member may be manufactured with large tolerances without impacting the function of the wastegate or the efficiency of the turbine.

The first sealing surface may have a major dimension defined by a maximum distance between opposing points on an outer edge of the first sealing surface. The minor dimension of the second sealing surface may be larger than the major dimension of the first sealing surface.

Where the valve port is elliptical, the raised rim may be in the form of an elliptical ring, the elliptical outer edge of the first sealing surface may be defined by a major diameter and a minor diameter. The major dimension of the elliptical outer edge of the first sealing surface may be its major diameter. Where the first sealing surface has a constant width, the major dimension of the first sealing surface may be equivalent to the major dimension of the valve port plus two times the width of the first sealing surface.

The first sealing surface may be coplanar with the valve port.

The first sealing surface may be tapered away from the valve port. The first sealing surface may be angled relative to the plane of the valve port. The first sealing surface may be angled away from the valve port. The first sealing surface may take the form of a shallow truncated cone. When the valve member is in the closed position, a portion of the first sealing surface proximate the inner edge of the first sealing surface may sealing engage the second sealing surface. When the valve member is in the closed position, the inner edge of the first sealing surface may bed in to the second sealing surface. Beneficially, the tapered sealing surface controls the location of the seal formed between the first and second sealing surfaces (proximate the inner edge of the first sealing surface. Controlling the location of the seal allows for accurate calculation of the area of the valve member upon which the valve port fluid pressure applies, therefore the wastegate actuator can be accurately tuned to improve the efficiency of the wastegate and/or prevent leakage through the wastegate that may reduce the efficiency of the turbine.

The first sealing surface may be flat or concave.

The raised rim may be formed in the turbine housing by interpolation milling. The wastegate inlet passageway may be formed in the turbine housing by interpolation milling.

Beneficially, manufacturing by interpolation milling may allow the valve port and the raised rim to be closely toleranced. Having a closely toleranced valve port and raised rim allows for accurate calculation of the area of the valve member upon which the valve port fluid pressure applies, therefore the wastegate actuator can be accurately tuned to improve the efficiency of the wastegate and/or prevent leakage through the wastegate that may reduce the efficiency of the turbine.

The wastegate inlet passageway may be formed in the turbine housing by 5-axis milling. The raised rim may be formed in the turbine housing by 5-axis milling. Beneficially, manufacturing by 5-axis milling allows the first sealing surface to be formed as a shallow truncated cone and/or the wastegate inlet passageway to be formed along an axis that is not coaxial with the raised rim.

According to a second aspect there is provided a turbocharger comprising the turbine of the first aspect.

### BRIEF DESCRIPTION OF THE DRAWINGS

Exemplary embodiments of the disclosure will now be described with reference to the accompanying drawings, in which:

FIG. 1 is a schematic cross-section view of a turbine and a wastegate according to an embodiment of the present disclosure;

FIG. 2 is a schematic cross-section view of a wastegate inlet passageway and a valve member of the wastegate of FIG. 1;

FIG. 3 is a plan view of the wastegate inlet passageway and the valve member of the wastegate of FIG. 1;

FIG. 4a is a perspective cross-section view of the turbine and the wastegate of FIG. 1, wherein the wastegate valve is in a closed configuration;

FIG. 4b is a perspective cross-section view of the wastegate inlet passageway and the valve member of the wastegate of FIG. 1, wherein the wastegate valve is in an open configuration;

FIG. 5 is a cutaway perspective view of a turbocharger comprising a wastegate according to the present disclosure;

FIG. 6 is a schematic cross-section view of an actuator for controlling a wastegate according to the present disclosure;

FIG. 7a is a section view of a turbine and a wastegate according to another embodiment of the present disclosure;

FIG. 7b is an elevation view of the wastegate inlet passageway of FIG. 7a;

FIG. 7c is a detailed view of the raised rim of FIG. 7a;

FIG. 8a is a section view of a turbine and a wastegate according to another embodiment of the present disclosure;

FIG. 8b is an elevation view of the wastegate inlet passageway of FIG. 8a;

FIG. 8c is a detailed view of the raised rim of FIG. 8a

FIG. 9a is a section view of a turbine and a wastegate according to another embodiment of the present disclosure;

FIG. 9b is an elevation view of the wastegate inlet passageway of FIG. 9a; and

FIG. 9c is a detailed view of the raised rim of FIG. 9a. Referring to FIG. 1, a turbine 10 comprises a turbine housing 12 defining a turbine inlet 14, a turbine chamber 16, and a turbine outlet 18. The turbine further comprises a turbine wheel 20 that is disposed within the turbine chamber 16 and is rotatable about a turbine axis a, on a shaft 24. In use, there is provided a conventional flow path A through the turbine. Fluid flows into the turbine 10 via the turbine inlet 14 and impinges on the turbine wheel 20 thereby causing rotation of the turbine wheel 20 around the turbine axis a,. The fluid is redirected by the turbine wheel 20 to flow out of the turbine 10 via the turbine outlet 18.

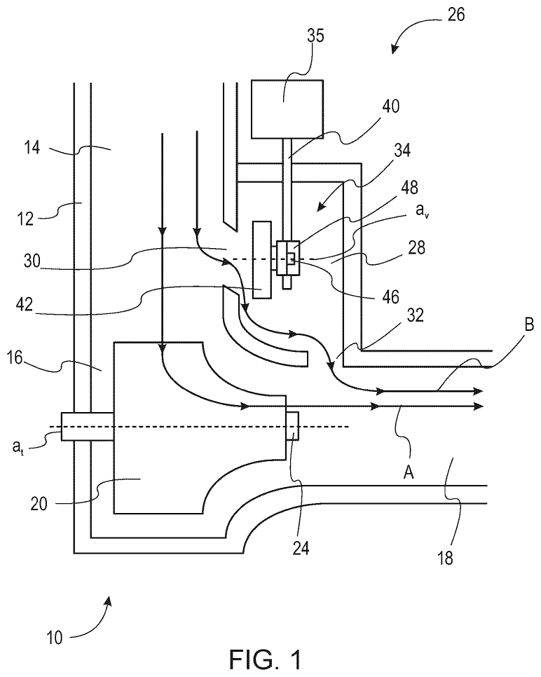

### DETAILED DESCRIPTION OF THE DRAWINGS

In order to regulate the volume of fluid impinging on the turbine wheel 20, and therefore control the speed of rotation of the turbine wheel 20, the turbine is provided with a wastegate 26 that defines a bypass flow path B. The wastegate 26 provides a way of controlling the speed of the turbine wheel 20 by selectively diverting an amount of exhaust gas away from the turbine wheel 20.

The wastegate 26 comprises a wastegate chamber 28 having a chamber inlet 30 and a chamber outlet 32. The chamber inlet 30 provides a flow path between the turbine inlet 14 and the wastegate chamber 28. The chamber outlet 32 provides a flow path between the wastegate chamber 28 and the turbine outlet 18. Fluid flowing along the bypass flow path B flows from the turbine inlet 14, through the chamber inlet 30 to the wastegate chamber, and through the chamber outlet 32 to the turbine outlet 18. In other embodiments, the chamber outlet may provide a flow path between the wastegate chamber and the atmosphere, and the bypass flow path may end in the atmosphere rather than the turbine outlet.

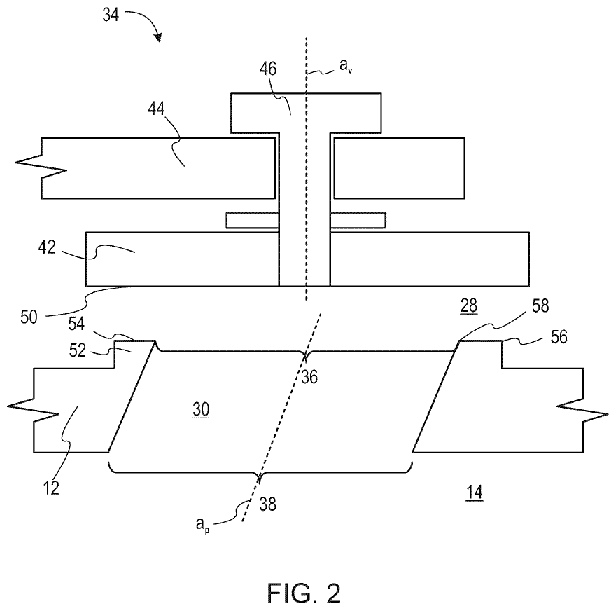

The wastegate 26 further comprises a wastegate valve 34. The wastegate valve 34 comprises a shaft 40 and a valve member 42 connected to the shaft 40 via an arm 44 (see FIG. 2). The valve member 42 is mounted to the arm via a pin 46. The wastegate valve 34 has a valve axis a, which extends through the centre of the pin 46 and the valve member 42. The valve member 42 is free to rotate around the valve axis av. The valve member 42 being free to rotate may reduce uneven wear on the valve member 42.

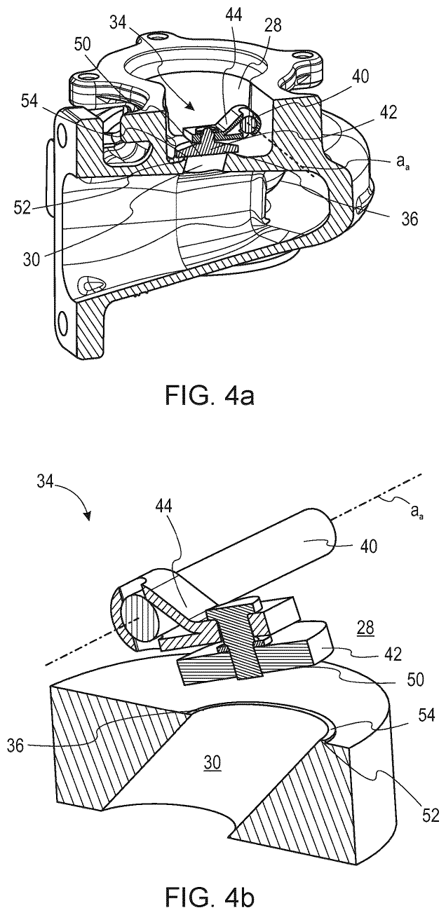

The wastegate valve 34 has an open configuration and a closed configuration to control fluid flow along the bypass flow path B. The wastegate valve 34 is moveable between the open and closed configurations by an actuator 35. The shaft 40 is connected to the actuator 35 which controls the wastegate valve 34 between the open and closed configurations via the shaft. In particular, the shaft 40 is rotatable by the actuator 35 to move the valve member 42 between a closed position (see FIG. 4a) in which the valve member 42 blocks the chamber inlet 30 to prevent fluid flow along the bypass flow path B, and an open position (see FIG. 4b) in which the valve member 42 is spaced from the chamber inlet to permit fluid flow along the bypass flow path B.

FIG. 2 shows the chamber inlet 30 and the wastegate valve 34 in greater detail. The chamber inlet 30 is a passage, referred to herein as a wastegate inlet passageway, formed in the turbine housing 12. The wastegate inlet passageway 30 has a passage axis aₚ. The wastegate inlet passageway extends through the turbine housing along the passage axis aₚ between a valve port 36 proximal the wastegate chamber 28 and a turbine port 38 proximal the turbine inlet 14. The turbine housing 12 comprises a raised rim 52 that surrounds the valve port 36. The raised rim 52 and the wastegate inlet passageway 30 are formed in the turbine housing 12 by interpolation milling (other types of processing may be used to form the raised rim). The raised rim 52 is conformal to the valve port 36. Thus, the inner surface of the raised rim 52 provides a small extension to the wastegate inlet passageway 30. The raised rim 52 defines a sealing surface 54, which is a first sealing surface of the wastegate 26. The sealing surface 54 of the raised rim 52 is flat. The sealing surface 54 of the raised rim 52 is co-planar with the valve port 36. The sealing surface 54 is bounded between an outer edge 56 and an inner edge 58. The inner edge 58 corresponds to the valve port 36. The valve member 50 also comprises a sealing surface 50, which is a second sealing surface of the wastegate 26. The sealing surface 50 of the valve member 50 is flat. As will be described in greater detail with reference to FIGS. 4a and 4b, the sealing surface 50 of the valve member 42 and the sealing surface 54 of the raised rim 52 are sealingly engageable to block fluid flow along the bypass flow path B.

With continued reference to FIG. 2, the sealing surface 54 of the raised rim 52, the valve port 36 and the turbine port 38 define parallel planes. The passage axis a, is at an oblique angle to the plane of the sealing surface 54, the plane of the valve port 36 and the plane of the turbine port 38. The wastegate inlet passageway 30 being angled allows for flexibility in the packaging arrangement of the turbine 10 and the wastegate 26. The wastegate inlet passageway 30 being angled relative to the plane of the turbine port 38 can also provide a preferential flow angle for fluid flowing along the bypass flow path B from the turbine inlet 14.

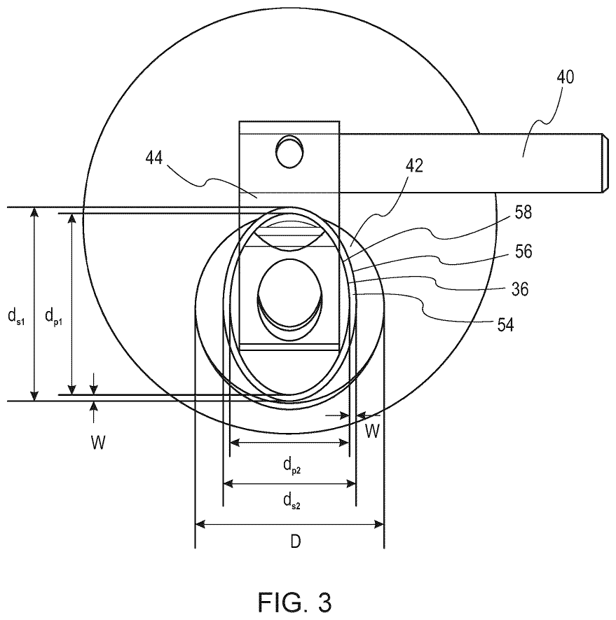

The wastegate inlet passageway 30 has a circular cross section when taken transverse to the passage axis aₚ. As can be seen in FIG. 3, the valve port 36 is elliptical in shape as a result of the wastegate inlet passageway 30 having a circular axial cross-section and extending along an axis at an oblique angle relative to the plane of the valve port 36. The valve port 36 is defined by a major dimension, which in the depicted example is a major port diameter dₚᵢ of the elliptical valve port 36, and a minor dimension, which in the depicted example is a minor port diameter dₚ2 of the elliptical valve port 36. The sealing surface 54 of the raised rim 52 has an elliptical annular form. The outer and inner edges 56, 58 are elliptical. The sealing surface 54 of the raised rim is defined by a width W between the inner and outer edges 58, 56. The width W of the sealing surface 54 is constant. The width W of the sealing surface 54 is small relative to the major and minor port diameters dₚᵢ, dₚ2. The width W of the sealing surface 54 may be between 1 mm and 5 mm. Preferably, such as in the present embodiment, the width W of the sealing surface 54 is between 1 mm and 3 mm. The preferred width W of the sealing surface 54 provides an optimal width that is large enough to be sufficiently durable to the environment within the turbine and hot gases that may pass through the wastegate, and small enough to provide an accurate sealing location, as will be discussed in greater detail below. Furthermore, minimizing the width of the land reduces the amount of free space around the valve port that is required to give line of sight and access during machining. The outer edge 56 of the sealing surface 54 is defined by a major dimension, which in the depicted example is a major diameter dₛᵢ of the elliptical outer edge 56, and a minor dimension, which in the depicted example is a minor diameter dₛ2 of the elliptical outer edge 56, wherein dₛi=dₚi+2W and dₛ2=dₚ2+2W.

Referring to FIGS. 2 and 3 in combination, the valve member 42 takes the form of a disc and has a circular sealing surface 50. In other embodiments, the sealing surface of the valve member may be non-circular. In other embodiments the sealing surface of the valve member may have the same shape as the valve port. Where the sealing surface of the valve member is non-circular, rotation of the valve member around the valve axis may be prevented by an anti-rotation feature, e.g. an anti-rotation pin or the like, thus ensuring that the non-circular sealing surface of the valve member remains correctly orientated relative to the non-circular valve port. The valve sealing surface 50 is defined by a minor dimension, which in the depicted example is the diameter D of the circular sealing surface. The diameter D is equal to or greater than the major diameter dₚᵢ of the valve port. Preferably, as in the present embodiment, the diameter D is also equal to or greater than the major diameter dₛ1 of the outer edge 56 of the sealing surface 54 defined by the raised rim 52. In other embodiments. the valve member may have a non-circular sealing surface in which case the minor dimension is a minimum distance between opposing points on an outer edge of the sealing surface. The minor dimension is equal to or greater than the major dimension of the valve port. Preferably, the minor dimension is also equal to or greater than the major dimension of the outer edge of the sealing surface defined by the raised rim. The relative dimensions of the sealing surface 50 of the valve member 42 and at least the valve port 36 ensure that the valve member 42 can fully cover the valve port 36, regardless of the rotational position of the valve member 42 around the valve axis aᵥ, and despite the valve port 36 having a different planar shape to the shape of the sealing surface 50 of the valve member 52.

FIGS. 4a and 4b show the wastegate valve 34 in closed and open configurations respectively. When the wastegate valve 34 is in the closed configuration, as in FIG. 4a, the valve member 42 is in the closed position. The valve member 42 in its closed position abuts the raised rim 52. The center of the sealing surface 50 of the valve member 42 is generally aligned with the center of the valve port 36, i.e. the point at which the valve axis aᵥ intersects the sealing surface 50 of the valve member 42 meets the point at which the passage axis aₚ intersects the valve port 36. The sealing surfaces 50, 54 are sealingly engaged to prevent fluid flow through the valve port 36, thus fluid cannot flow from the wastegate inlet passageway 30 to the wastegate chamber 28 and the bypass fluid flow path B is blocked. When the wastegate valve 34 is in the open configuration, as in FIG. 4b, the valve member 42 is in the open position. When the valve member 42 is in the open position the sealing surface 50 of the valve member 42 is spaced apart from the sealing surface 54 of the raised rim 52. Fluid flow through the valve port 36 from the wastegate inlet passageway 30 to the wastegate chamber 28 is not impeded. Instead, fluid flow from the wastegate inlet passageway 30 to the wastegate chamber 28 is permitted between the raised rim 52 and the valve member 42. Thus fluid flow along the bypass fluid flow path is permitted.

The wastegate valve 34 is moved from the closed configuration to the open configuration, and the valve member is moved from the closed position to the open position, by the shaft 40 pivoting on an actuation axis a, through the center of the shaft 40. The pivoting of the shaft 40 causes the arm 44 and therefore also the valve member 42 to rotate around the actuation axis a,. The valve member 42 moves through an angle of rotation sufficient to provide clearance between the sealing surface 50 of the valve member 42 and the sealing surface 54 of the raised rim 52. This valve type is referred to as a swing valve. In other embodiments, other types of valves may be used, for example a poppet valve.

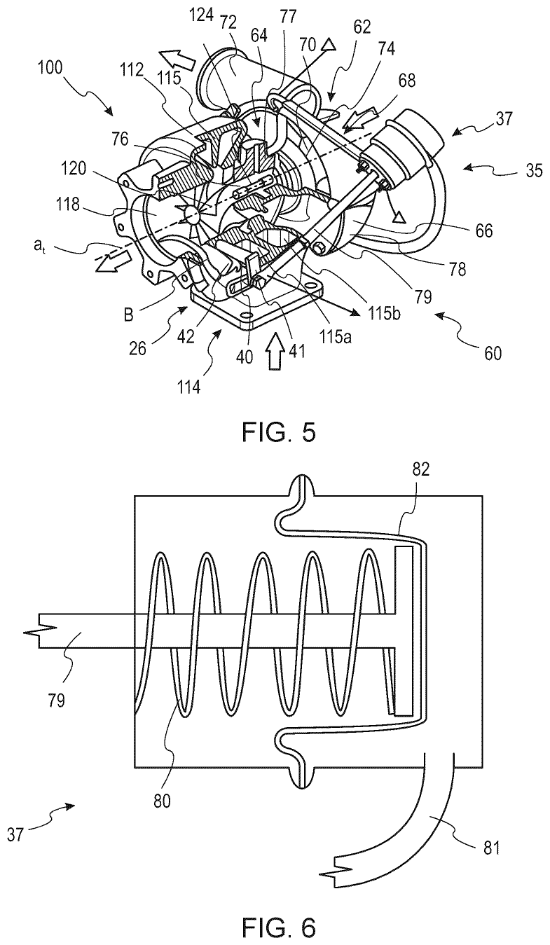

FIG. 5 shows the wastegate 26 implemented in a turbocharger 60. The turbocharger 60 comprises a turbine 100 that substantially corresponds to the turbine 10 previously described, with the exception that the turbine inlet 114 comprises a twin volute 115. In other embodiments, the turbocharger may comprise the turbine 10. The twin volute 115 comprises a first passage 115a and a second passage 115b that are both in fluid communication with the turbine wheel 120. The bypass flow path B extends from the first passage 115a of the twin volute to the turbine outlet 118. The turbocharger 60 further comprises a compressor 62 and a bearing arrangement 64. The compressor 62 comprises a compressor housing 66 defining a compressor inlet 68, a compressor chamber 70, a compressor volute 78 and a compressor outlet 72. Within the compressor chamber 70 is a compressor wheel 74. The compressor wheel 74 is mounted on the shaft 124 upon which the turbine wheel 120 is also mounted, such that the compressor wheel 74 and the turbine wheel 120 rotate together. The bearing arrangement 64 comprises bearings 76 within a bearing housing 77. The bearings 76 support the shaft 124 between the compressor wheel 74 and the turbine wheel 20. The bearing housing 77 is coupled between the turbine housing 112 and the compressor housing 66.

Exhaust gases from an internal combustion engine (not shown) are passed to the turbine 100. The exhaust gases enter the turbine inlet 114 defined by the turbine housing 112. The exhaust gases impinge upon the turbine wheel 120 which causes rotation of the turbine wheel 120 about the turbine axis a,. Rotation of the turbine wheel 120 drives rotation of the shaft 124 and therefore rotation of the compressor wheel 74.

Rotation of the compressor wheel 74 causes air from the atmosphere to be drawn into the compressor inlet 68. The air passes through the compressor wheel 74 and into the compressor volute 78 defined by the compressor housing 66. Due to the kinetic energy imparted on the incoming air by the compressor wheel 74, the air in the compressor volute 78 is at a higher pressure than the air entering the compressor inlet 68. The compressed air exits the compressor 62 via the compressor outlet 72 where it is delivered to an intake manifold of the internal combustion engine (not shown).

The wastegate 26 reduces the amount of exhaust gas impinging on the turbine wheel 20 by providing the bypass flow path B from the turbine inlet 114 to the turbine outlet 118 and therefore regulates the rotation of the turbine wheel 120. When the wastegate 26 is utilised in the turbocharger 60, that control of the rotation of the turbine wheel 20 translates to control of the boost pressure of the compressed air exiting the compressor 62. This provides benefits in preventing detrimental flow conditions in the compressor, for example compressor surge.

Wastegates according to embodiments of the disclosure may be actuated by a variety of means, including hydraulic or electric actuators. The turbocharger 60 comprises a pneumatic actuator 35. The actuator 35 provides control of the wastegate 26 according to the boost pressure of compressed air delivered by the compressor 62. The actuator 35 comprises a control arrangement 37 and an operator arm 79. A first end of the operator arm 79 is coupled to the control arrangement 37 such that the control arrangement 37 can control bi-directional axial movement of the operator arm 79. A second end of the operator arm 79 is coupled to the shaft 40 of the wastegate 26 via a linkage 41. The linkage 41 translates the axial movement of the operator arm 79 to rotation of the shaft 40. Axial movement of the operator arm 79 in a first direction causes rotation of the shaft 40 to move the valve member 42 from a closed position to an open position. Axial movement of the operator arm 79 in a second direction opposite the first direction causes rotation of the shaft 40 to move the valve member 42 from the open position to the closed position. Other linkage arrangements and other actuation arrangements may be used.

With reference to FIGS. 5 and 6, the control arrangement 37 comprises a biasing member 80, i.e. a spring, that biases the operator arm 79 in the second direction to hold the valve member 42 in the closed position, and a diaphragm 82 that is exposed to the boost pressure of the compressed air exiting the compressor 62 via a pressure signal pipe 81. The operator arm 79 is moved in the first direction to move the valve member 42 to the open position when the combination of the boost pressure acting on the diaphragm 82 and the pressure of exhaust gas in the wastegate inlet passageway 30 acting on the valve member 42 in the closed position overcomes the bias of the spring 80.

When the actuator 35 is tuned prior to being assembled with the turbine, air is applied to the diaphragm 82 to move the valve member 42 away from the valve port 36 into the open position and the pressure of exhaust gas in the wastegate inlet passageway 30 acting on the valve member 42 is assumed based on nominal geometry of the turbine and the wastegate to determine the appropriate spring force required. Therefore, in order to tune the actuator 35 to open at a predetermined boost pressure acting on the diaphragm 82, the pressure of exhaust gas in the wastegate inlet passageway 30 acting on the valve member 42 should be predicted. The pressure of exhaust gas in the wastegate inlet passageway 30 acting on the valve member 42 directly corresponds to the effective area of the valve member 42 upon which the exhaust gases act. The effective area of the valve member 42 upon which the exhaust gases act depends on the location at which the seal is formed between the sealing surface 50 of the valve member 42 and the sealing surface 54 of the raised rim 52. The sealing location may be anywhere that the sealing surface 50 of the valve member 42 is in contact with the sealing surface 54 of the raised rim 52 between the inside and outside edges 58, 56 of the sealing surface 54 of the raised rim 52. The effective area consists of a known portion, which is the area of the valve port 36, plus an unknown portion, which is an undetermined area of the sealing surface 54 of the raised rim 52 which the sealing surface 50 of the valve member 42 is in contact depending on the sealing location. The width W of the sealing surface 54 of the raised rim 52 being small relative to the major and minor diameters dpi, dₚ20f the valve port 36 results in the unknown portion of the effective area being small relative to the known portion of the effective area, for example the unknown portion of the effective area may be 10% of the known portion of the effective area. Accordingly, the uncertainty and error margin in predicting the effective area is reduced by controlling the geometry of the port and the sealing surfaces, and thus predicting the pressure of exhaust gas in the wastegate inlet passageway 30 acting on the valve member 42 is reduced so that the actuator 35 can be tuned with greater accuracy. Furthermore, the variation between products is reduced. By accurately tuning the actuator 35, the risk of the wastegate valve being moved between the open and closed configurations at inappropriate times is reduced and the associated adverse effects on the performance of the turbocharger are mitigated.

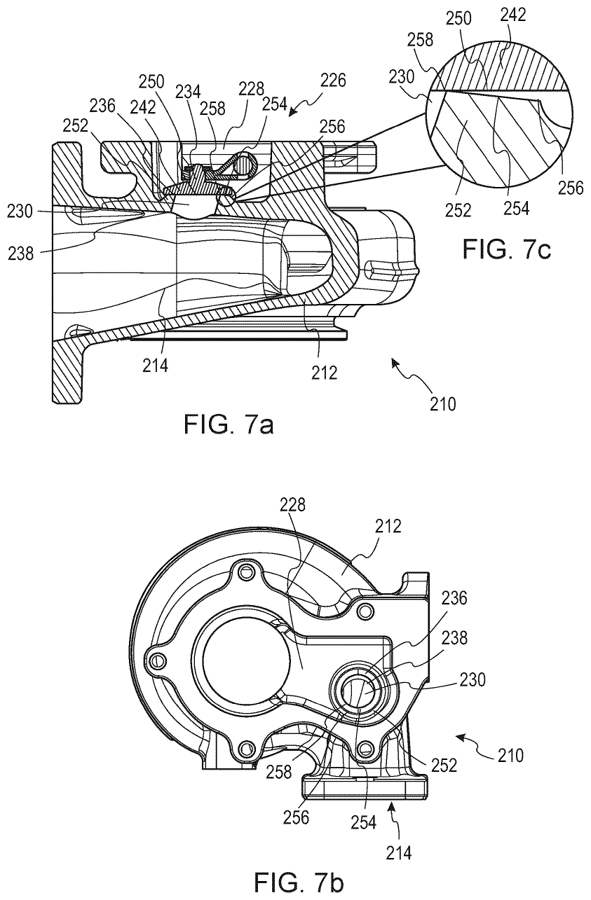

FIGS. 7a, 7b and 7c show an alternative turbine 210 provided with a wastegate 226. The turbine 210 and wastegate 226 substantially correspond to the turbine 10 and wastegate 26 except for the features that will be described. Like features are provided with like reference numerals augmented by 200.

The turbine 210 comprises a turbine housing 212 defining a turbine inlet 214. In use, there is provided a conventional flow path through the turbine. Fluid flows into the turbine 210 via the turbine inlet 214 and impinges on a turbine wheel thereby causing rotation of the turbine wheel. The fluid is redirected by the turbine wheel to flow out of the turbine 210 via a turbine outlet. In order to regulate the volume of fluid impinging on the turbine wheel, and therefore control the speed of rotation of the turbine wheel, the turbine is provided with wastegate 226 that defines a bypass flow path and selectively diverts exhaust gas away from the turbine wheel. The wastegate 226 comprises a wastegate chamber 228 having a chamber inlet 230 and a chamber outlet. The wastegate 226 further comprises a wastegate valve 234 (the wastegate valve 234 has been removed in FIG. 7b for clarity). The wastegate valve 234 has an open configuration and a closed configuration to control fluid flow along the bypass flow path.

The chamber inlet 230 is a passage, referred to herein as a wastegate inlet passageway, formed in the turbine housing 212. The wastegate inlet passageway 230 extends through the turbine housing 212 between a valve port 236 proximal the wastegate chamber 228 and a turbine port 238 proximal the turbine inlet 214. The turbine housing 212 comprises a raised rim 252 that surrounds the valve port 236. The raised rim 252 is conformal to the valve port 236 thus the inner surface of the raised rim 252 provides an extension to the wastegate inlet passageway 230. The raised rim 252 defines a sealing surface 254, which is a first sealing surface of the wastegate 226. The sealing surface 254 is bounded between an outer edge 256 and an inner edge 258. The inner edge 258 corresponds to the valve port 236.

The wastegate valve 234 comprises a sealing surface 250, which is a second sealing surface of the wastegate 226. The sealing surface 250 of the valve member 242 is flat. The sealing surface 250 of the valve member 242 and the sealing surface 254 of the raised rim 252 are sealingly engageable to block fluid flow along the bypass flow path. The sealing surface 254 of the raised rim 252 is tapered away from the valve port 236 therefore it is a portion of the sealing surface 254 of the raised rim 252 proximate the inner edge 258 of the sealing surface 254 that forms a seal with the sealing surface 250 of the valve member 242. Beneficially, controlling the geometry of the sealing surface 254 of the raised rim 252 with a taper to provide the seal between the sealing surfaces 250, 254 proximate the inner edge 258 of the sealing surface 254 increases the certainty in estimating the location of the seal and therefore reduces error in estimating the effective area of the valve member 242 upon which the exhaust gases apply a load so that the actuator can be more accurately tuned. The taper angle of the sealing surface 250 relative to a plane of the valve port 236 may be between 1° and 10°. In the present embodiment the taper angle is 5°. In alternative embodiments the taper angle may preferably be 2.5°. The preferred taper angle ensures that the raised rim is sufficiently robust to withstand the environment within the wastegate and any hot gases that may pass through the valve port.

The wastegate inlet passageway 230 extends along an axis at an oblique angle to the plane of the valve port 236 and the plane of the turbine port 238. The wastegate inlet passageway 230 has a circular cross section when taken transverse to the axis of the passageway 230. The valve port 236 is elliptical in shape as a result of the wastegate inlet passageway 230 having a circular axial cross-section and extending along an axis at an oblique angle relative to the plane of the valve port 236. The sealing surface 254 of the raised rim 252 has an elliptical annular form. The outer and inner edges 256, 258 are elliptical. The sealing surface 254 of the raised rim is defined by a width between the inner and outer edges 258, 256. The width of the sealing surface 254 is constant. The width of the sealing surface 54 may be between 1 mm and 5 mm. Preferably, such as in the present embodiment, the width of the sealing surface 254 is between 3 mm and 5 mm. The preferred width W of the sealing surface 254 provides an optimal width that is large enough to be sufficiently durable to the environment within the turbine and hot gases that may pass through the wastegate, and small enough to provide an accurate sealing location so that the gas force acting on the valve member in the closed position can be accurately estimated and the wastegate actuator can be accurately tuned.

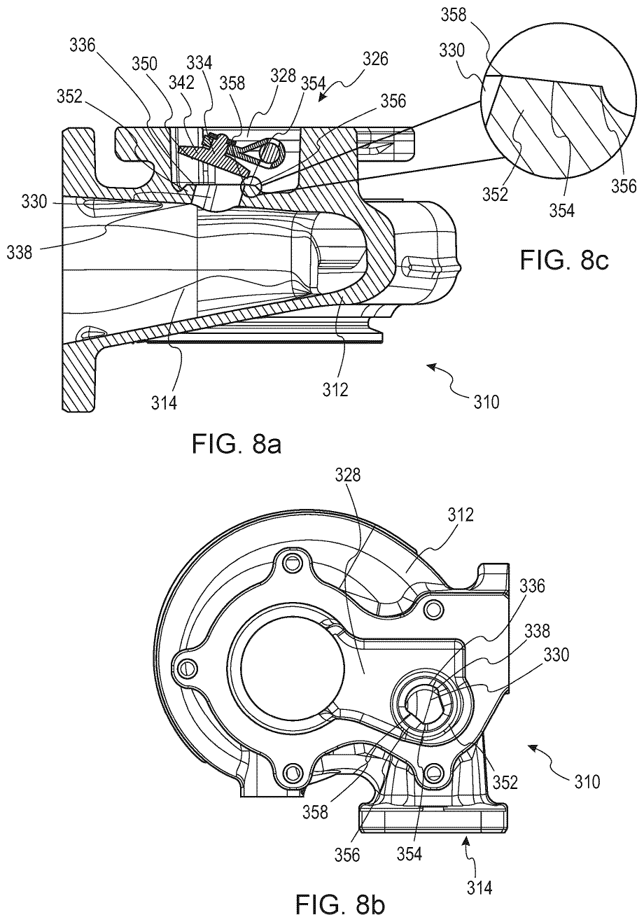

FIGS. 8a, 8b and 8c show an alternative turbine 310 provided with a wastegate 326. The turbine 310 and wastegate 326 substantially correspond to the turbine 10 and wastegate 26 except for the features as will be described. Like features are provided with like reference numerals augmented by 300.

The turbine 310 comprises a turbine housing 312 defining a turbine inlet 314. In use, there is provided a conventional flow path through the turbine. Fluid flows into the turbine 310 via the turbine inlet 314 and impinges on a turbine wheel thereby causing rotation of the turbine wheel. The fluid is redirected by the turbine wheel to flow out of the turbine 310 via a turbine outlet. In order to regulate the volume of fluid impinging on the turbine wheel, and therefore control the speed of rotation of the turbine wheel, the turbine is provided with wastegate 326 that defines a bypass flow path and selectively diverts exhaust gas away from the turbine wheel. The wastegate 326 comprises a wastegate chamber 328 having a chamber inlet 330 and a chamber outlet. The wastegate 326 further comprises a wastegate valve 334. The wastegate valve 334 has an open configuration and a closed configuration to control fluid flow along the bypass flow path.

The chamber inlet 330 is a passage, referred to herein as a wastegate inlet passageway, formed in the turbine housing 312. The wastegate inlet passageway 330 extends through the turbine housing 312 between a valve port 336 proximal the wastegate chamber 328 and a turbine port 338 proximal the turbine inlet 314. The turbine housing 312 comprises a raised rim 352 that surrounds the valve port 336. The raised rim 352 is conformal to the valve port 336 thus the inner surface of the raised rim 352 provides an extension to the wastegate inlet passageway 330. The raised rim 352 defines a sealing surface 354, which is a first sealing surface of the wastegate 326. The sealing surface 354 is bounded between an outer edge 356 and an inner edge 358. The inner edge 358 corresponds to the valve port 336.

The valve port 336 is defined by a major dimension. The wastegate inlet passageway 330 extends along an axis at an oblique angle to the plane of the valve port 336 and the plane of the turbine port 338. The wastegate inlet passageway 330 has a non-circular cross section therefore the valve port 336 (and the inner edge 358 of the sealing surface 354) is non-circular and non-elliptical. The major dimension of the valve port 336 is a maximum distance between opposing points on the valve port 336. The outer edge 356 of the sealing surface 354 is circular. The sealing surface 354 of the raised rim is defined by a width between the inner and outer edges 358, 356. The width of the sealing surface 354 may be between 1 mm and 5 mm. Preferably, such as in the present embodiment, the width of the sealing surface 354 may be between 3 mm and 5 mm. The outer edge 356 of the sealing surface 354 is defined by a major dimension, which in the depicted example is the diameter of the circular outer edge 356.

The valve member 342 also comprises a sealing surface 350, which is a second sealing surface of the wastegate 326. The valve sealing surface 350 is defined by a minor dimension, which in the depicted example is the diameter of the circular sealing surface 350. The diameter is equal to or greater than the major dimension of the valve port. Preferably, as in the present embodiment, the diameter is also equal to or greater than the major diameter of the outer edge 356 of the sealing surface 354 defined by the raised rim 352. The sealing surface 350 of the valve member 342 is flat. The sealing surface 350 of the valve member 342 and the sealing surface 354 of the raised rim 352 are sealingly engageable to block fluid flow along the bypass flow path. The sealing surface 354 of the raised rim 352 is tapered away from the valve port 336 therefore it is a portion of the sealing surface 354 proximate the inner edge 358 of the sealing surface 354 of the raised rim 352 that forms a seal with the sealing surface 350 of the valve member 342. The taper angle of the sealing surface 354 relative to a plane of the valve port 336 may be between 1° and 10°. In the present embodiment the taper angle is 5°. In alternative embodiments the taper angle may preferably be 2.5°.

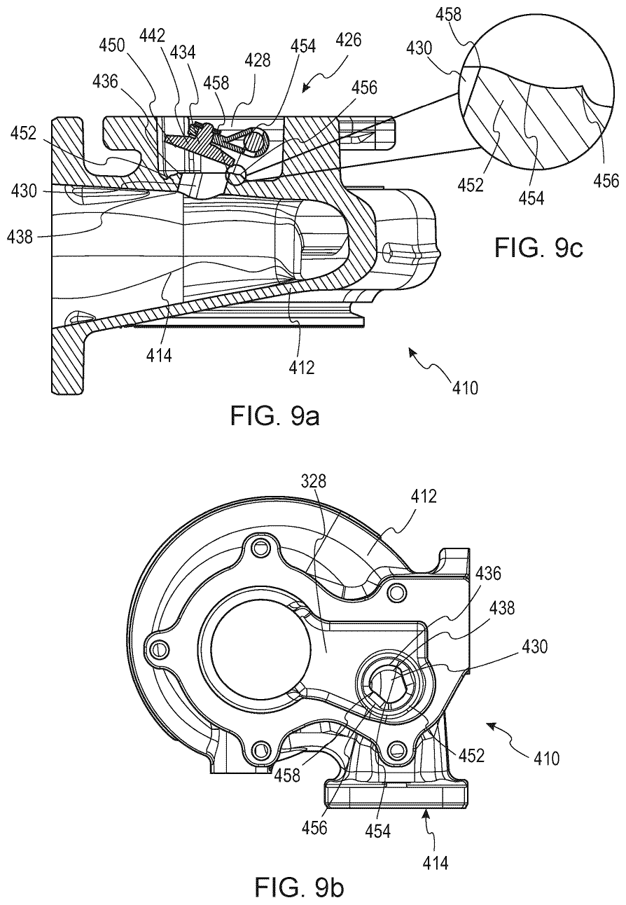

FIGS. 9a, 9b and 9c show an alternative turbine 410 provided with a wastegate 426. The turbine 410 and wastegate 426 substantially correspond to the turbine 10 and wastegate 26 except for the features as will be described. Like features are provided with like reference numerals augmented by 400.

The turbine 410 comprises a turbine housing 412 defining a turbine inlet 414. In use, there is provided a conventional flow path through the turbine. Fluid flows into the turbine 410 via the turbine inlet 414 and impinges on a turbine wheel thereby causing rotation of the turbine wheel. The fluid is redirected by the turbine wheel to flow out of the turbine 410 via a turbine outlet. In order to regulate the volume of fluid impinging on the turbine wheel, and therefore control the speed of rotation of the turbine wheel, the turbine is provided with a wastegate 426 that defines a bypass flow path and selectively diverts exhaust gas away from the turbine wheel. The wastegate 426 comprises a wastegate chamber 428 having a chamber inlet 430 and a chamber outlet. The wastegate 426 further comprises a wastegate valve 434. The wastegate valve 434 has an open configuration and a closed configuration to control fluid flow along the bypass flow path.

The chamber inlet 430 is a passage, referred to herein as a wastegate inlet passageway, formed in the turbine housing 412. The wastegate inlet passageway 430 extends through the turbine housing 412 between a valve port 436 proximal the wastegate chamber 428 and a turbine port 438 proximal the turbine inlet 414. The turbine housing 412 comprises a raised rim 452 that surrounds the valve port 436. The raised rim 452 is conformal to the valve port 436 thus the inner surface of the raised rim 452 provides an extension to the wastegate inlet passageway 430. The raised rim 452 defines a sealing surface 454, which is a first sealing surface of the wastegate 426. The sealing surface 454 is bounded between an outer edge 456 and an inner edge 458. The inner edge 458 corresponds to the valve port 436.

The valve port 436 is defined by a major dimension. The wastegate inlet passageway 430 extends along an axis at an oblique angle to the plane of the valve port 436 and the plane of the turbine port 438. The wastegate inlet passageway 430 has a non-circular cross section, therefore the valve port 436 is non-circular and non-elliptical. The major dimension of the valve port 436 is a maximum distance between opposing points on the valve port 436.

The sealing surface 454 of the raised rim is defined by a width between the inner and outer edges 458, 456. The width of the sealing surface 454 is constant. The outer edge 456 of the sealing surface 454 is defined by a major dimension, which is a maximum distance between opposing points on the sealing surface 454. Because the width of the sealing surface 454 is constant, the major dimension of the sealing surface 454 is the major dimension of the valve port 436 plus two widths.

The valve member 442 also comprises a sealing surface 450, which is a second sealing surface of the wastegate 426. The valve sealing surface 450 is defined by a minor dimension, which in the depicted example is the diameter of the circular sealing surface. The diameter is equal to or greater than the major dimension of the valve port 436. Preferably, as in the present embodiment, the diameter is also equal to or greater than the major dimension of the outer edge 456 of the sealing surface 454 defined by the raised rim 452.

The sealing surface 454 of the raised rim 452 is rounded. In particular, the sealing surface 454 of the raised rim 452 is concave. The concave sealing surface 450 has a radius of 6 mm. The sealing surface 450 of the valve member 442 and the sealing surface 454 of the raised rim 452 are sealingly engageable to block fluid flow along the bypass flow path. The inner edge 458 of the sealing surface 450 of the raised rim 452 is closer to the valve member than the outer edge 456, therefore it is the inner edge 458 of the sealing surface 454 of the raised rim 452 that forms a seal with the sealing surface 450 of the valve member 442. Beneficially, controlling the geometry of the sealing surface 454 in this way increases the certainty in estimating the sealing location and therefore reduces error in estimating the effective area of the valve member 442 upon which the exhaust gases apply a load. The reduced estimating error allows the actuator to be more accurately tuned.

The above description is intended to be merely exemplary and non-limiting. It should be understood that features defined above in accordance with any aspect of the present disclosure or any specific embodiment of the disclosure may be utilized, either alone or in combination with any other defined feature, in any other aspect or embodiment or to form a further aspect or embodiment of the disclosure.

1. A turbine comprising:
a wastegate chamber;
a turbine housing defining a turbine inlet, the turbine housing comprising:
a wastegate inlet passageway defining a flow path between the turbine inlet and the wastegate chamber, wherein the wastegate inlet passageway comprises a turbine port proximal the turbine inlet and a noncircular valve port proximal the wastegate chamber, and a raised rim surrounding the non-circular valve port and conformal to the shape of the non-circular valve port, wherein the raised rim comprises a first sealing surface; and
a valve member comprising a second sealing surface, wherein the valve member is moveable between a closed position in which the second sealing surface forms a seal with the first sealing surface to prevent fluid flow along the flow path and an open position in which the second sealing surface is spaced apart from the first sealing surface to permit fluid flow along the flow path

2. The turbine according to claim 1, wherein the non-circular valve port defines a plane, and wherein the wastegate inlet passageway extends along an axis at an oblique angle to the plane of the non-circular valve port.

3. The turbine of claim 1, wherein the non-circular valve port has a major dimension defined by a maximum distance between opposing points on the valve port, wherein the second sealing surface has a minor dimension defined by a minimum distance between opposing points on an outer edge of the second sealing surface, and wherein the minor dimension of the second sealing surface is greater than the major dimension of the non-circular valve port.

4. The turbine according to claim 3, wherein the second sealing surface defines a valve axis through its center, and wherein the valve member is free to rotate around the valve axis.

5. The turbine according to claim 3, wherein the non-circular valve port is elliptical, and wherein the elliptical valve port is defined by a major diameter and a minor diameter, and wherein the major dimension of the elliptical valve port is its major diameter.

6. The turbine according to claim 5, wherein the first sealing surface has the form of an elliptical ring.

7. The turbine according to claim 1 wherein the first sealing surface has a constant width.

8. The turbine according to claim 7, wherein the first sealing surface has a width of 5 mm or smaller.

9. The turbine according to claim 3, wherein the second sealing surface is circular, and wherein the minor dimension of the second sealing surface is the diameter of the second sealing surface.

10. The turbine according to claim 3, wherein the first sealing surface has a major dimension defined by a maximum distance between opposing points on an outer edge of the first sealing surface, and wherein the minor dimension of the second sealing surface is larger than the major dimension of the first sealing surface.

11. The turbine according to claim 10, when dependent on at least claim 6, wherein the elliptical outer edge of the first sealing surface is defined by a major diameter and a minor diameter, and wherein the major dimension of the elliptical outer edge of the first sealing surface is its major diameter.

12. The turbine according to claim 1, wherein the raised rim and/or the wastegate inlet passageway are formed in the turbine housing by interpolation milling.

13. The turbine according to claim 1, wherein the first sealing surface and the valve port are coplanar.

14. The turbine according to claim 1, wherein the first sealing surface is tapered away from the valve port, and wherein in the closed position the second sealing surface forms a seal with an inner edge of the first sealing surface.

15. The turbocharger comprising a turbine according to claim 1.

16. The method of manufacturing a turbine according to claim 1, the method comprising forming the raised rim by interpolation milling.
